(19) United States
(12) Patent Application Publication
(10) Pub. No.: US 2014/0042659 A1
(43) Pub. Date: Feb. 13, 2014

(54) METHOD FOR PRODUCING PHARMACEUTICAL PRODUCTS FROM A MELT MATERIAL

(71) Applicant: AUTOMATIK PLASTICS MACHINERY GMBH, Grossostheim (DE)

(72) Inventor: Reinhardt-Karsten Mürb, Aschaffenburg (DE)

(73) Assignee: AUTOMATIK PLASTICS MACHINERY GMBH, Grossostheim (DE)

(21) Appl. No.: 14/058,886

(22) Filed: Oct. 21, 2013

Related U.S. Application Data
(63) Continuation of application No. PCT/EP2012/001703, filed on Apr. 19, 2012.

(30) Foreign Application Priority Data
Apr. 21, 2011 (DE) 102011018403.1

(51) Int. Cl. B29C 47/00

(52) U.S. Cl. CPC B29C 47/0011
USPC 264/83; 264/148

(57) ABSTRACT

A method for producing pharmaceutical products from a melt material, wherein the melt material emerges from nozzles in a perforated plate, and is then granulated. A motor-driven cutter arrangement having at least one blade is opposite the perforated plate so that it cuts pellets emerging from nozzles in the perforated plate. A gaseous coolant flows through a housing which adjoins the perforated plate and encloses the at least one blade. The pellets of the melt material are then solidified in the coolant. Coolant is introduced from a separate inlet chamber that circumferentially encloses the housing in the area of rotation and from an inlet nozzle arrangement extending circumferentially between the inlet chamber and the housing. Coolant is introduced circumferentially from all sides essentially radially inward. A substantially centripetal flow of the coolant is produced in the area of rotation, and the coolant and pellets are conveyed to an outlet.

### CROSS REFERENCE TO RELATED APPLICATIONS

This application is a Continuation and claims priority to and the benefit of co-pending International Patent Application No. PCT/EP2012/001703, filed on Apr. 19, 2012, entitled “METHOD FOR PRODUCING PHARMACEUTICAL PRODUCTS FROM A MELT MATERIAL,” which claims priority to DE Application No. 102011018403.1, which was filed on Apr. 21, 2011. These references are incorporated in their entirety herein.

### FIELD

The present embodiments generally relate to a method for producing pharmaceutical products from a melt material.

### BACKGROUND

Melt material in general today is processed and treated, for example through granulation. Generally speaking, extruders or melt pumps are frequently used in the granulation of melt material, hitherto in particular of plastics. These extruders or melt pumps press molten plastic raw material through nozzles of a perforated plate into a coolant, such as water. In this process, the material emerging through the openings of the nozzles is cut there by a cutter arrangement with at least one rotating blade to produce pellets. Corresponding devices, which carry out methods for underwater granulation are known as underwater granulators, for example under the product name SPHERO™ from the firm Automatik Plastics Machinery GmbH.

Prior art by the same applicant provides a method and a device for granulating thermoplastic material, wherein a flow-optimized, radial inflow of a cooling fluid is provided in order to thus reduce the energy expenditure for the cutter drive in the cooling fluid. Special solutions to the problems of manufacturing pharmaceutical products while incorporating an appropriate design are not addressed in the referenced application.

In the manufacture of pharmaceutical products from a melt material, what is of critical importance is uniform size, and thus weight, and also the achievable uniformity of shape of the products. In addition, large quantities are desired, which makes it necessary for an appropriate production method to run reliably for a very large number and volume of pellets (for example, up to 50 million pieces per hour).

Prior art provides a solid extended release drug form in which shaping takes place after extrusion of an appropriate melt composition from an extruder and a die plate using so-called hot-cut pelletization, where the intent is to obtain particles that are a specific shape, such as spherical. However, this document says nothing about the feasibility of the manufacturing process, which is described therein merely by way of example, for large quantities of pellets to be produced under real production conditions.

Systems for carrying out hot-cut pelletization in air as the coolant have been on the market for quite a long time, since they represent relatively easy to build machines for granulating extruded thermoplastics. In these machines, strands of melt emerging from the perforated plate are chopped by blades rotating as closely as possible to the surface and formed into pellets by the inertia inherent in the small pieces of strand material. As a result of the rotation of the blades, air is drawn in from the environment or the interior of the housing, and the air directs the pellets more or less freely and centrifugally away from the cutting location.

The problems that occur in these systems are a result of the poor cooling of the blades, which over the course of time can overheat and stick, as well as the tendency toward general sticking and clogging of such systems, especially at high throughput rates with large quantities of pellets to be produced under real production conditions.

Furthermore, pellets produced in this way tend to have cylindrical and irregular shapes, especially when the viscosity of the melt material is relatively high, whereas in the case of pharmaceutical materials in particular, a great many pellets of uniform size and shape are more likely to be required in the downstream applications.

The object of the present invention is to provide a method for producing pharmaceutical products from a melt material that overcomes the disadvantages of the prior art and in particular that allows effective granulation of pellets of pharmaceutical products with uniform pellet size as well as uniform and consistent shape, even for large quantities of pellets to be produced, at high volume, and under real production conditions in a relatively simple and economical way.

This object is attained according to the invention by a method with the features of claim 1. Preferred embodiments of the invention are defined in the dependent claims.

### BRIEF DESCRIPTION OF THE DRAWINGS

The detailed description will be better understood in conjunction with the accompanying drawings as follows:

FIG. 1 is a schematic cross-sectional view of a granulating device for carrying out the method according to the invention.

The present embodiments are detailed below with reference to the listed Figures.

### DETAILED DESCRIPTION OF THE EMBODIMENTS

Before explaining the present method in detail, it is to be understood that the method is not limited to the particular embodiments and that it can be practiced or carried out in various ways.

The present embodiments generally relate to an inventive method for producing pharmaceutical products from a melt material. The melt material emerges from nozzles in a perforated plate and is then granulated, wherein a motor-driven cutter arrangement having at least one blade is located opposite the perforated plate so that the at least one blade passes over the nozzles in the perforated plate and in so doing cuts pellets of the emerging melt material.

A housing is provided that adjoins the perforated plate and encloses at least the at least one blade of the cutter arrangement and through which housing flows a coolant, so that in the process, the pellets of the melt material are solidified in the coolant.

The coolant is introduced into the housing from an inlet apparatus comprised of a separate inlet chamber that circumferentially encloses the housing in the area of rotation of the at least one blade and of an inlet nozzle arrangement extending circumferentially between the inlet chamber and the housing. The coolant can be introduced circumferentially from all sides radially inward from the outside, which is to say centripetally, or essentially radially inward from the outside, wherein a centripetal or at least substantially centripetal flow of the coolant is produced at least in the area of rotation. In addition the coolant and the pellets located therein are conveyed to an outlet in the housing. The coolant can be a gaseous coolant.

In the method according to the invention, a flow rate of gaseous coolant, such as air, an inert gas such as nitrogen, or a reaction gas (which is selected such that it can enter into a desired chemical reaction with the pharmaceutical melt material to be granulated, that is circumferentially uniform, i.e. remains constant or at least substantially constant over the circumference), is thus provided by the appropriately designed inlet chamber and by the inlet nozzle arrangement and/or by means of one or more control device(s). The flow accordingly is introduced radially from all sides into the area of rotation in the housing, flowing inward from the outside.

According to the invention, the gaseous coolant or cooling fluid required for cooling and carrying away the freshly cut pellets, specifically with regard to the moisture sensitivity that usually is present in pharmaceutical materials, is thus supplied to the housing of the corresponding granulating device in such a manner that it presents as little resistance as possible to the at least one blade of the cutter arrangement while at the same time the pellets of the pharmaceutical melt material are removed from the rotation area, and thus the cutting area, as quickly as possible.

Thus a high specific throughput of material (large quantities of relatively small pellets) is possible, while at the same time it is possible to avoid clumping of the pellets as a result of the effective cooling according to the invention and the uniform flow behavior that can be achieved according to the invention of the gaseous coolant with the pellets of pharmaceutical melt material located therein.

According to the invention the gaseous coolant is delivered to the housing through the circumferentially placed inlet nozzle arrangement from the outside to the inside, which is to say centripetally, or essentially from the outside to the inside in the area of rotation, which is in the region of the cutting plane.

This inlet nozzle arrangement is fed through the separate inlet chamber extending circumferentially around the housing. Due to the appropriately provided design of the inlet apparatus, and/or specification of the dimensions of the inlet nozzle arrangement, and/or by means of the one or more control device(s), the gaseous coolant can also be given an (additional) rotational speed upon entry to the housing or upon entry to the cutting chamber that corresponds approximately to the rotational speed of the at least one blade of the cutter arrangement.

The acceleration of the gaseous coolant to the desired speed that takes place in this process, i.e., the energy required to reach the corresponding angular momentum, can be obtained from the pressure of the gaseous coolant. The additional rotational speed of the gaseous coolant, which can be provided above, can be adjusted either mechanically by means of the design of the inlet nozzle arrangement and/or through controlling the flow rate of the gaseous coolant, and can be matched to various other process parameters (material flow rate, type of melt material to be granulated, size of the pellets, and so on). The number and speed of the blade/blades can also be adjusted accordingly.

Since, according to the invention, the gaseous coolant can flow into the area of rotation with approximately the same speed as the rotational speed of the at least one blade, it will flow past the at least one blade, or if applicable through an intermediate space between multiple blades, of the cutter arrangement and carry the freshly cut pellets out of the area of rotation along with it. The gaseous coolant can reliably prevent sticking of the pellets even at relatively high flow rates.

In the resultant flow, as the axis of rotation of the at least one blade of the cutter arrangement is approached the corresponding rotational speed of the gaseous coolant will increase and thus the corresponding centrifugal force will increase, so that the inward flow movement from outside becomes progressively more difficult and is ultimately prevented. The gaseous coolant will thus flow into the space behind the at least one blade of the cutter arrangement and in this process will flow away from the area of the perforated plate and the area of rotation in the housing in a helical flow.

In the method according to the invention, the centripetal or at least substantially centripetal flow of the coolant can thus be imposed on the coolant flowing into the housing, and preferably also an additional angular momentum that is oriented to match the direction of rotation of the at least one blade can also be imposed, by means of the shape of the inlet chamber and the inlet nozzle arrangement and/or by means of one or more control device(s) in the region of the inlet nozzle arrangement in the area of rotation.

Preferably the additional angular momentum can be great enough so that the corresponding speed of the gaseous coolant in the direction of rotation of the cutter arrangement is as great as the rotational speed of the cutter arrangement.

Consequently, a further optimized flow control of the coolant, as explained above, can be rendered possible in this embodiment of the method according to the invention. In this design, the flow of the gaseous coolant preferably proceeds such that it straightens perpendicular to the perforated plate and flows away. Pellets produced there are thus blown away from the perforated plate in a perpendicular to helical direction.

The volume flow rate of the gaseous coolant and transport medium flowing in accordance with the invention is chosen such that the pellets are immediately separated after cutting, which is to say in great quantities.

For example, every hour 4 kg polymer/pharmaceutical melt material with a density of 1,200 kg/m³ emerges from a perforated plate having 24 perforations and a reference diameter dLp of approximately 60 mm, and is cut by 9 blades with n=3,900 rpm into 13,900 pellets per second having a diameter of 0.5 mm.

The pellets should have a distance of approximately 1 cm from one another in all directions. The mass flow rate of the gaseous cooling and transport medium is approximately 8 kg/h here and carries 4 kg/h transported material, which corresponds to a ratio of transported material to transport medium (“loading”) of 0.5. This is far less than is customary in pneumatic transport, where even in dilute phase conveying a loading ratio of 10 to 20 is customary, and in dense-phase conveying a loading ratio of 60 and higher is customary. In contrast, therefore, the cooling and transport air is supplied in great excess.

If one considers the heat flows that occur, one can ascertain that when warm air at, e.g., 20° C. is supplied, depending on the polymer/pharmaceutical melt material a final temperature of the air and pellets located therein of approximately 55° C. is reached. For more intensive or even faster cooling, therefore, the quantity of air would have to be increased or the supply temperature would have to be reduced further.

It is also possible in the method according to the invention for a flow rate and/or a pressure and/or a direction of the gaseous coolant delivered through the inlet apparatus to be controlled by means of a control unit such that a direction of the flow of the coolant into the housing is regulated by this means. For example, the control unit can have or control the one or more control device(s).

Preferably, therefore, according to the inventive method the ratio in the housing of the mass flow rate of the gaseous coolant to the mass flow rate of the pellets located therein can be a loading ratio, defined as the mass of pellets per hour to the mass of the gaseous coolant per hour, in the range from 0.3 to 0.7, preferably a loading ratio of 0.5. Sticking of pellets can thus be avoided especially reliably, even at high flow rates, since sufficient coolant is present to surround the pellets individually without clumping and thus to cool and transport them.

In a preferred manner according to the invention, after the rotation region, the pellets located in the gaseous coolant can flow onward into the region of the housing outlet, where they are directed against a wall of the housing at an angle of less than 10 degrees, so that a rolling motion is imposed on the pellets located in the gaseous coolant there. Consequently, in a preferred manner according to the invention, the uniform shaping of the pellets can be achieved especially reliably.

The solidification of the pellets can additionally be supported here by the means that the wall of the housing is cooled, for example in a double-walled design through which cooling fluid flows.

For further flow optimization in the region of the outlet, the outlet can be located in the region of the housing of the inventive device facing away from the inlet apparatus in the inflow direction. A uniform outflow of the gaseous coolant with the pellets of pharmaceutical melt material contained therein can thus be achieved, by which means possible clumping in the housing, and in particular in the region of the outlet, can additionally be avoided especially reliably. In this case, the pellets can be collected in a discharge spiral and carried away from the housing tangentially, for example.

The invention is explained in detail below by way of example with reference to the attached figure and with reference to the cited examples.

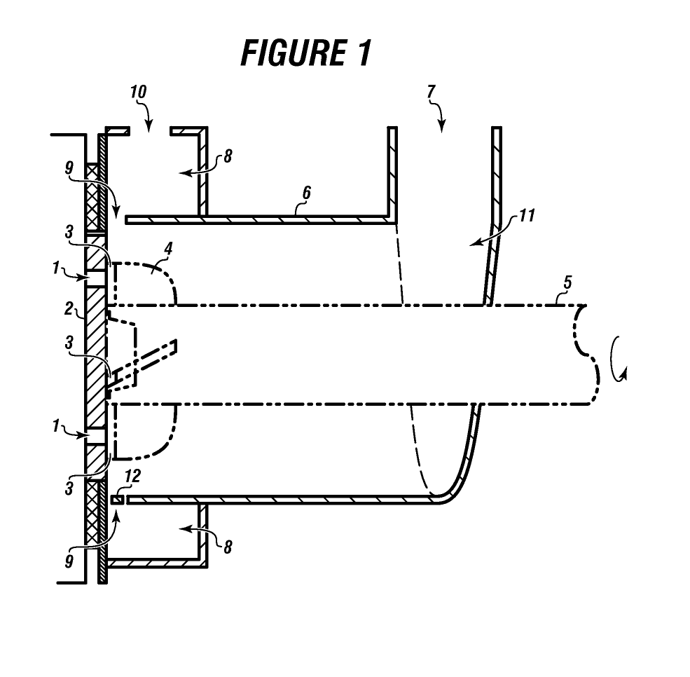

FIG. 1 schematically shows a cross-sectional view of a device for granulating pharmaceutical melt material emerging from nozzles 1 in a perforated plate 2.

The granulating device shown schematically in FIG. 1 has a perforated plate 2 with nozzles 1 provided therein, wherein the arrangement of the nozzles 1 is substantially rotationally symmetric and the remaining design of the device is also rotationally symmetric or substantially rotationally symmetric.

According to the representation in FIG. 1, associated with the perforated plate 2 is a cutter arrangement with at least one blade 3, which is composed of a blade carrier 4, located on a blade shaft 5. The cutter arrangement is driven by a motor (not shown in FIG. 1), so that the at least one blade 3 passes over the nozzles 1 in the perforated plate 2 and in so doing cuts pellets of the pharmaceutical melt material emerging from the nozzles 1.

The pharmaceutical melt material can be melted in a conventional manner and can be transported, for example by an extruder or a melt pump (not shown in FIG. 1), to the area of the perforated plate 2 and forced out of the nozzles 1 there.

The device has a housing 6 that adjoins the perforated plate 2 and thus defines a cutting chamber, which in operation is, according to the invention, filled and passed through by a gaseous coolant which can be air, wherein the housing 6 encloses at least the one blade 3 and the blade carrier 4 as well as at least a portion of the blade shaft 5.

The blade shaft 5 is passed out of the housing in the part of the housing facing away from the perforated plate 2 in a fluid-tight manner, and the motor (not shown in FIG. 1) is provided that drives the at least one blade 3 into rotational motion via the blade shaft 5.

An inlet apparatus with a separate inlet chamber 8 is provided, which circumferentially encloses the housing 6 in the area of rotation of the at least one blade 3, and with an inlet nozzle arrangement 9 placed to extend circumferentially between the inlet chamber 8 and the housing 6, wherein the inlet nozzle arrangement 9 in the case shown in FIG. 1 is a circumferentially extending annular gap nozzle with a nozzle width of, for example, 3 mm that is constant over the circumference.

According to the invention, the inlet chamber 8 has a cross-section that decreases over its circumference, i.e., circumferentially, in the direction of rotation of the at least one blade 3, starting from an inlet opening 10 for the coolant in the inlet chamber 8.

According to the design shown in FIG. 1, multiple control devices 12 are provided so that a circumferentially uniform flow rate of gaseous coolant flows through the inlet nozzle arrangement 9. Thus, in accordance with the invention, the gaseous coolant is introduced into the housing 6 circumferentially from all sides radially inward from the outside, or essentially radially inward from the outside, through the inlet nozzle arrangement 9 between the inlet chamber 8 and the housing 6. In this process, a centripetal or at least substantially centripetal flow of the gaseous coolant is produced at least in the area of rotation of the at least one blade 3.

The control devices 12 are arranged such that in the circumferential direction a possibility always remains for the gaseous coolant to flow into all regions of the inlet chamber 8. The control devices 12 serve to control the flow of the gaseous coolant, rather than to divide individual regions over the circumference of the separate inlet chamber 8.

The individual control devices 12 can be distributed evenly over the circumference of the inlet chamber 8 or the inlet nozzle arrangement 9, for example. The individual control devices 12 can be fastened in a stationary way, e.g., by welding appropriate control vanes to the walls. The control device(s) 8 can also be designed to be adjustable individually or, together, such as by a control unit, wherein parameters such as the angle of incidence can be suitably adjustable.

As shown in FIG. 1, an outlet 7 is located in the region of the housing 6 facing away from the inlet apparatus. After the rotation region, the gaseous coolant with the pellets located therein flows onward into the region of the outlet 7 of the housing 6, where they are directed against a wall of the housing 6 at an angle of less than 10 degrees, so that a rolling motion is imposed on the pellets of pharmaceutical melt material located in the gaseous coolant there.

As shown in the representation in FIG. 1, an outlet section 11 with a helical shape toward the outlet 7 is provided here, which appropriately guides the flow of the gaseous coolant and the pellets contained therein that are flowing out through the outlet 7, thus also permitting a pressure buildup in this region of the housing 6 and/or in the outlet 7, specifically as a result of the back pressure resulting in the spiral-shaped outlet section 1. A suitable spiral-shaped outlet section is also possible in the design.

The device shown in FIG. 1 serves to carry out the method according to the invention for the application of manufacturing pharmaceutical products or pellets from a corresponding melt material.

Thus, tests using the Applicant's method with a corresponding or similar system of have already been carried out with large quantities of pellets to be produced under real production conditions (although not yet under process parameters optimized in all respects). The results of the tests with different pharmaceutical melt materials are summarized in Table 1.

The specified temperatures here relate to the temperatures of the system parts (extruder heat zones, perforated plate, etc.). The actual temperature of the melt strands when emerging from the perforated plate may well be a few degrees higher. For all granulated pharmaceutical melt materials, air was used as the gaseous coolant according to the invention, with the temperatures of the air being from 15° C. to 60° C.

TABLE 1

| | Temperatures of the | |
|---|---|---|
| | die plate and | Shape of |
| | surrounding system | pellets |
| Material | parts | produced |
| Hoechst wax PE190 | 100° C.-130° C. | Foamed agglomerates |
| Plasdone K12 | 130° C.-170° C. | Flakes of arbitrary shape |
| Eudragit RS PO | 140° C.-180° C. | Flakes d ≈ 1.5 mm |
| 5/21 Eudragit RL PO + | 140° C.-170° C. | Flakes d ≈ 2 mm |
| 15/21 Eudragit RS PO + | | |
| 1/21 CaSt | | |
| 10% acetaminophen + | 50° C.-70° C. | Cylindrical, d ≈ 1 mm |
| 20% PEG + 70% | | |
| Basewax | | |
| 10% acetaminophen + | 100° C.-140° C. | Spherical, d ≈ 1 mm |
| 90% CaSt | | |

While these embodiments have been described with emphasis on the embodiments, it should be understood that within the scope of the appended claims, the embodiments might be practiced other than as specifically described herein.

What is claimed is:

1. A method for producing pharmaceutical products from a melt material, wherein the melt material emerges from nozzles in a perforated plate and is then granulated, wherein:
a. a motor-driven cutter arrangement having at least one blade is located opposite the perforated plate so that the at least one blade passes over the nozzles in the perforated plate and in so doing cuts pellets of the emerging melt material;
b. a housing is provided that adjoins the perforated plate and encloses the at least the one blade of the motor-driven cutter arrangement and through which the housing flows a coolant, so that in the process the pellets of the melt material are then solidified in the coolant;
c. the coolant comprises a gaseous coolant and is introduced into the housing from an inlet apparatus comprised of a separate inlet chamber that circumferentially encloses the housing in the area of rotation of the at least one blade and of an inlet nozzle arrangement extending circumferentially between the inlet chamber and the housing;
d. the coolant is introduced circumferentially from all sides radially inward from the outside, or essentially radially inward from the outside, wherein a centripetal or at least substantially centripetal flow of the coolant is produced at least in the area of rotation, and in addition the coolant and the pellets located therein are conveyed to an outlet in the housing; and
e. the ratio in the housing of the mass flow rate of the gaseous coolant to the mass flow rate of the pellets located therein is a loading ratio, defined as the mass of pellets per hour to the mass of the gaseous coolant per hour, in the range from 0.3 to 0.7.

2. The method of claim 1, wherein the loading ratio is 0.5.

3. The method of claim 1, wherein after the rotation region, the pellets located in the gaseous coolant can flow onward into the region of the housing outlet, where they are directed against a wall of the housing at an angle of less than 10 degrees, so that a rolling motion is imposed on the pellets located in the gaseous coolant there.

4. The method of claim 2, wherein after the rotation region, the pellets located in the gaseous coolant can flow onward into the region of the housing outlet, where they are directed against a wall of the housing at an angle of less than 10 degrees, so that a rolling motion is imposed on the pellets located in the gaseous coolant there.

5. The method of claim 1, wherein the gaseous coolant comprises:
a. air;
b. an inert gas; or
c. a reaction gas, wherein the reaction gas is selected such that it can enter into a desired chemical reaction with the pharmaceutical melt material to be granulated.

6. The method of claim 2, wherein the gaseous coolant comprises:
a. air;
b. an inert gas; or
c. a reaction gas, wherein the reaction gas is selected such that it can enter into a desired chemical reaction with the pharmaceutical melt material to be granulated.

7. The method of claim 3, wherein the gaseous coolant comprises:
a. air;
b. an inert gas; or
c. a reaction gas, wherein the reaction gas is selected such that it can enter into a desired chemical reaction with the pharmaceutical melt material to be granulated.

8. The method of claim 4, wherein the gaseous coolant comprises:
a. air;
b. an inert gas; or
c. a reaction gas, wherein the reaction gas is selected such that it can enter into a desired chemical reaction with the pharmaceutical melt material to be granulated.
